(19) United States
(12) Patent Application Publication
(10) Pub. No.: US 2006/0154201 A1
(43) Pub. Date: Jul. 13, 2006

(54) Elongate medical handpiece

(75) Inventors: Thomas Braun, Biberach (DE); Herbert Lott, Bad Wurzach (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Kaltenbach & Voigt GmbH, Biberach (DE)

(21) Appl. No.: 11/298,089

(22) Filed: Dec. 8, 2005

(30) Foreign Application Priority Data
Dec. 13, 2004 (DE) 10 2004 060 089.9

(51) Int. Cl. A61C 3/00

(52) U.S. Cl. 433/114

(57) ABSTRACT

An elongate medical handpiece having a base part and a grip element at least partially surrounding this base part. In order to improve the construction of the handpiece, the grip element is of at least two grip parts, of which one is releasably connected with the other and/or with the base part and the grip parts are so configured that they lie on one another in a form-fitting manner.

### BACKGROUND OF THE INVENTION

1. Field of the Invention

The invention relates to an elongate medical handpiece having a base and a grip element.

2. Related Technology

Medical handpieces having a base with a grip element are adapted for the purpose of acting upon a treatment site of a human or animal body, including artificial body parts, e.g. a prosthesis or a model. Handpieces of this kind differ in their construction and their use for a particular medical purpose. A dental-medical handpiece is preferably suitable for treatment of teeth in the mouth of a patient. A medical-technical or dental-technical handpiece is, in contrast, put to use in a medical or dental laboratory for the working of artificial parts of the human or animal body, e.g. for the working of dentures, prostheses or models. In contrast, a dental-medical handpiece is also suitable for general medical use, since it is suitable not only for use in the restricted space of the mouth but also on other parts of the body.

Such handpieces are of elongate or rod-like form, wherein a grip element may form one or more of the forward region, the middle region, the rearward region, or the entire length of the handpiece.

Such a handpiece of the kind indicated above is described, for example, in US 2003-0014842 A1. This known handpiece has a base part in the form of a metal tube, on which there sits a grip sleeve, the cross-sectional form of which is waisted in its forward and rearward regions. These waistings are so pronounced that the fingers of the operating hand of the person carrying out treatment can engage in the waistings. In the rearward region of the base part, behind the grip part, there is disposed a valve which can be selectively closed and opened. With the rearward end of the base part, the handpiece can be connected with a suction line. This handpiece is thus a suction handpiece.

DE-PS 714 275 describes a handgrip for dental instruments, in particular for drilling and grinding handpieces. The handgrip has an equal-sided triangular cross-section, being tapered forwardly and its side surfaces being domed outwardly, the joining edges of the side surfaces being rounded off to both ends.

DE 41 00 452 A1 describes an electrical tool which has the form of a pistol, that is, the electrical tool consists of a forward tool section extending substantially straight and a rearward tool section extending transversely thereto, which forms a grip for the hand of the user.

The types of work or treatments that can be carried out with a handpiece of the present kind may rely on the use of force, in particular in the case of material removing work, e.g. boring or milling in a medical-technical or dental-technical laboratory, or involve fine motor control, in particular in the case of polishing or cleaning, rinsing or probing, as is the case with a medical or dental-medical treatment. As such, there is needed a secure and thereby ready grasping of the handpiece with the hand of the user in order to be able to hold, move, and guide the handpiece with a small or greater use of force and with a degree of attention as small as possible.

### GENERAL DESCRIPTION OF THE INVENTION

The invention provides a medical handpiece having a base and a grip element with improved construction, thereby providing a simple and economically producible design.

Accordingly, the invention provides an elongate medical handpiece having a base part and a grip element at least partly surrounding the base part, the grip element at least two grip parts one grip part being releasably connected with at least one of the other grip part and the base part, the grip parts being are so configured that they lie on one another in a form-fitting manner.

In another aspect, the invention provides, a handpiece adaptable to different uses or treatments or types of work. Accordingly, a handpiece according to this aspect of the invention an elongate medical handpiece having a base part and a grip element at least partially surrounding the base part, which grip element can be releasably attached to the base part, wherein at least two grip elements having different surface constitutions are provided, wherein grip parts can be selectively attached to the base part.

In both cases, the handpiece is ergonomically individually adaptable and at the same time is simple and economical to produce.

The invention applies the insight that for different kinds of work with the handpiece different grip requirements arise. For such types of work in which a torque is exercised with the handpiece on the treatment site, e.g. material removing work, in particular in the case of drilling and milling, there is required a particular fastness of grip in order to be able to position and handle the handpiece against the torque. For other fine types of work there is needed in contrast a surface constitution of the handpiece which favors sensitive working.

The invention thus is further based on the insight that such a configuration of the handpiece which makes possible an adaptation to different uses, treatments or kinds of work, makes the handpiece more complicated and more expensive.

In the case of the configuration according to a first aspect of the invention, there are provided at least two grip parts of which the one grip part is releasably connected with the other and/or with the base part, wherein the grip parts lie on one another in a form-fitting manner. Through this, the handpiece acquires a structural shape having at least two grip parts which lie on one another at their separation joint and thus avoid a gap between the grip parts, so that the manual grasping of the handpiece is not affected and dirt cannot collect in the separation joint.

The grip parts are in each case arranged transversely opposite one another, at least along one longitudinal section. Preferably only two grip parts are provided. There may, however, also be more, e.g., three, grip parts provided, which on at least one longitudinal section lie next to one another in the circumferential direction and form the closed grip element. Thereby, the grip parts lie on one another at least in the region of the outer edge of a separation joint extending between them. The grip parts may however, also lie on one another over an area at the mutually opposite separation joint surfaces, through which the stability is increased and the sealing of the separation joint improved. The separation joint extends, on at least one section of its length, in the longitudinal direction of the handpiece, whereby to the rear it runs out preferably as a longitudinal running separation joint. Thereby, the separation joint may extend in the region of its longitudinal section in a longitudinal plane or longitudinal middle plane of the handpiece. A section of the separation joint may however also extend transversely to the longitudinal direction of the handpiece, e.g. so that the transversely running section runs out to the side. In the region of this side run out, the one grip part projects over the other grip part in the longitudinal direction, preferably forwardly. This projecting longitudinal section of the one grip part is preferably formed ring-shaped.

It is advantageous to form at least one grip part at its outside with an elevation, which is preferably rounded and which may extend in the circumferential direction over the entire circumferential extent of the grip part or only over a part of this circumferential extent so that with regard to outer surface sections neighboring in the circumferential direction it is elevated. In similar manner, the elevation may extend also in the longitudinal direction of the grip part over its entire length or only over a part of its length, so that the elevation is raised above outer surface sections neighboring in the longitudinal direction. Within the scope of the invention, the elevation may be arranged only on the one grip part or both grip parts. The elevation increases the fastness of the grip element or handpiece, because the inclined flanks of the elevation offer bearing surfaces for the operating hand, so that the operating hand can guide the handpiece with a greater moment of movement or can support it against a greater movement element upon use of the handpiece.

If both grip parts have elevations, the height of these elevations may be the same or different. The at least one elevation is preferably arranged in the forward end region or in the forward half of the handpiece.

It is possible within the scope of invention to produce a handpiece with only one releasable grip part, which is not intended for exchange but remains on the handpiece. That is, the configuration in accordance with the invention makes it possible to produce and to market a handpiece having a non-releasable grip part as a basic configuration, which selectively can be completed to a handpiece with only one releasable grip part or can be completed to a handpiece with at least two different grip parts, which handpiece is adaptable to different kinds of work.

The invention provides a handpiece which in substance is based on the principle of leaving one part of the housing unaltered (base part) and configuring another part of the housing (grip part) to be alterable, namely in the form that the grip part can be placed in a cutout in the basic body. Thus, a modular housing structure is provided.

The configuration in accordance with the invention provides the possibility to adapt the handpiece to different kinds of work by means of the mounting or exchange of one of at least two releasable grip parts of different surface constitutions, which are suitable for different kinds of work.

In the case of the handpiece in accordance with a second aspect of the invention, at least two grip elements of different surface constitutions are provided of which the one grip element or the other grip element can be selectively attached to the base part. Through this, the handpiece can be adapted to different treatments or types of work through the selective mounting of the one or the other grip element.

As in the case of two grip parts of different surface constitutions, also the grip elements of different surface constitutions are so formed that with the operating hand, by form-fitting thereto or friction-based force application thereby, holding moments of force, in particular torques, can be exercised with the handpiece or the handpiece can be manually held or supported against holding moments of force, in particular torques, of different magnitudes.

Thereby, the configurations in accordance with the invention distinguish themselves, both in the case of different grip parts and also in the case of different grip elements, by simple and economically producible configurations, which make possible the selective adaptation of the handpiece in simple manner.

Also, the different surface constitutions of the grip elements can be achieved in terms of friction-based force application through manually graspable surface regions of different surface friction, and/or in terms of form-fitting, through differently formed elevations on the grip elements by form fitting.

### BRIEF DESCRIPTION OF THE DRAWINGS

Below, advantageous configurations of the invention will be explained in more detail with reference to preferred exemplary embodiments. There is shown:

FIG. 1 a medical or dental-medical or medical-technical or dental-technical handpiece in accordance with the invention, in perspective side view;

FIG. 2 the handpiece of FIG. 1 in a side view;

FIG. 3 the handpiece of FIG. 1 in a view from above;

FIG. 4 the handpiece of FIG. 1 in a rear view in accordance with arrow IV in FIG. 3;

FIG. 5 the handpiece of FIG. 1 in axial longitudinal section;

FIG. 6 a grip part of the handpiece of FIG. 5 in axial longitudinal section;

FIG. 7 a cross-section VII-VII of the handpiece of FIG. 5;

FIG. 8 a handpiece in accordance with the invention in a modified configuration;

FIG. 9 the handpiece according to FIG. 8, in a rear view in accordance with arrow IX in FIG. 8;

FIG. 10 the handpiece in accordance with the invention with a further modified configuration;

FIG. 11 the handpiece of FIG. 10, in a rear view in accordance with the arrow XI-XI in FIG. 10;

FIG. 12 a handpiece in accordance with the invention in a further modified configuration, in a side view;

FIG. 13 the handpiece of FIG. 12 in a disassembled condition;

FIG. 14 a grip element for the handpiece of FIG. 13, in axial section; and

FIG. 15 the cross-section XV-XV in FIG. 12.

### DETAILED DESCRIPTION

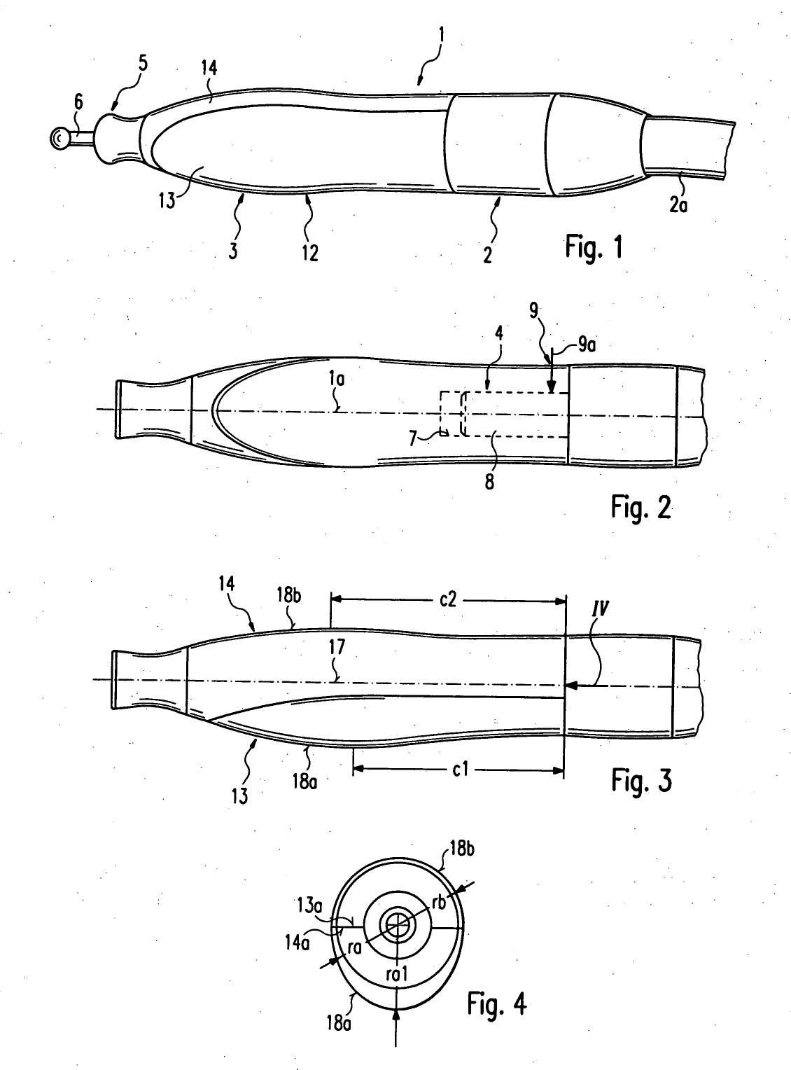

The handpiece, generally designated by 1 in FIG. 1, may be formed in one piece or in two pieces, with a rearward (to the right in FIG. 1) handpiece part, namely a connection part 2, and a forward handpiece part 3. In the case of a two-part form, as is usual in the case of a dental-medical handpiece 1, for example the rearward handpiece part and the forward handpiece part 3 are releasably connected with one another by a coupling 4, in particular a plug-in coupling, preferably a plug-in/turn coupling, indicated only in FIG. 2 by broken lines.

In the case of the present exemplary embodiment, there is disposed on the forward end of the handpiece 1 a holder device 5 having a forwardly (illustrated) or laterally (not illustrated) open insertion opening 5a for a tool 6, whereby the tool 6 may project to the side or forwardly. The forward handpiece part 3 may extend straight (illustrated) or curved (not illustrated) toward a side away from a lateral holding device 5, or in an angle shaped (not illustrated), as is known.

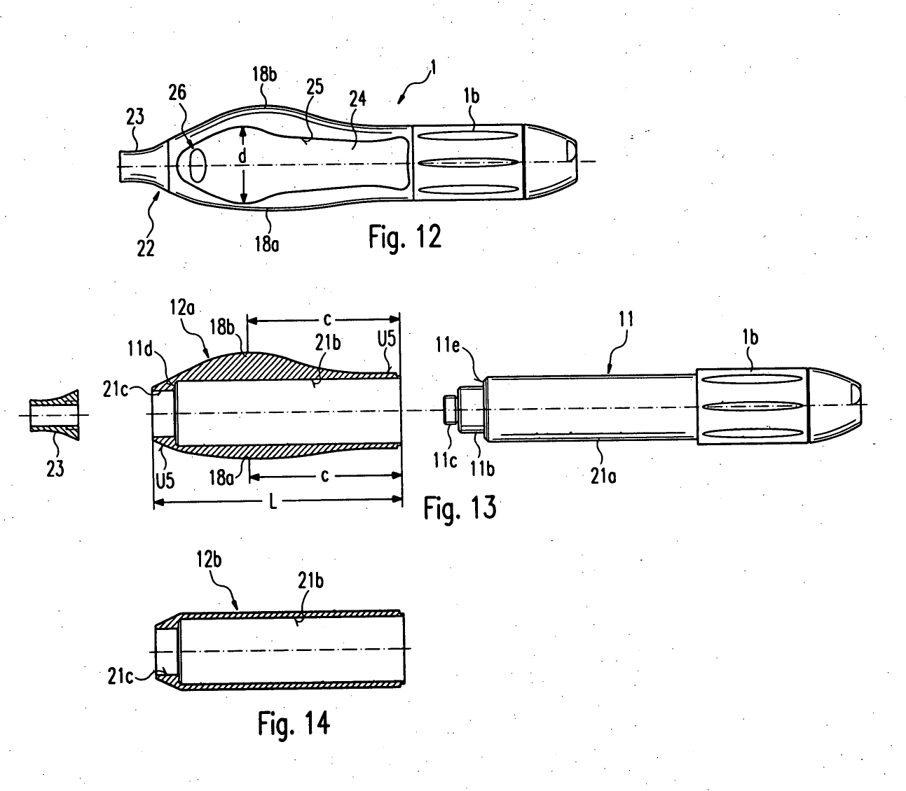

The plug-in/turn coupling 4 (FIG. 12) is formed by a hollow cylindrical recess 7 and a substantially cylindrical coupling pin 8 which can be inserted therein with slight play for movement. In the case of the present exemplary embodiment, the coupling recess 7 is arranged at the rearward end of the handpiece 1, and the substantially cylindrical coupling pin 8 extends forwardly from the connection part 2. In the coupled condition, the coupling recess 7 and the coupling pin 8 are releasably latched with one another by a latch device 9. This has a radially movable latch element 9a which is radially movably mounted in one coupling part and is biased by means of a spring force into a latching disposition penetrating the separation joint, in which latching position the latch element 9a engages into a ring groove in the other coupling part, in particular in the coupling pin 8. Such a latching device 9 latches self-actingly upon coupling, and upon decoupling can be overcome by the manual exercise of an axial pulling force, whereby the latch element 9a is displaced self-actingly into its release disposition. Upon coupling by plugging together, the coupling element 9a latches self-actingly into the latch recess preferably formed by means of a ring groove.

The handpiece 1 or the connection part 2 is connected with a flexible supply line 2a, which is connected to a non-illustrated control apparatus.

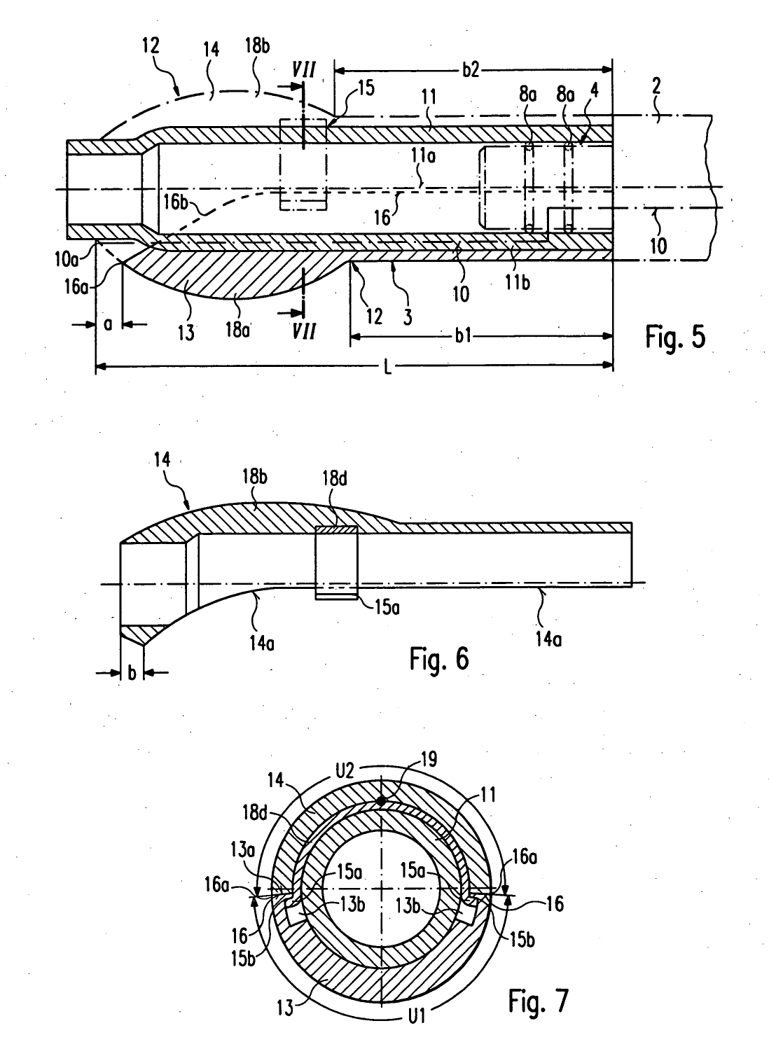

The handpiece 3 is preferably freely rotatable on the coupling pin 8, through which handling is improved. Through the plug-in/turn coupling there extends at least one media line 10 (FIG. 5) for a treatment or drive medium, e.g. water, compressed air or a water/air mixture (spray) or light. The media line 10 may extend axially through a radial separation joint (not illustrated) or Z-shaped through a hollow cylindrical separation joint between the coupling recess 7 and the coupling pin 8, whereby the media line 10 passes through the separation joint in the region of a ring groove in the coupling pin 8 or in the coupling recess 7 so that media passage is ensured in any rotational position. To both sides of the passage, the separation joint is sealed off by means of a sealing ring 8a (FIG. 5), which may be arranged in a ring groove in the wall of the coupling recess 7 or in the outer surface of the coupling pin 8. Through this, a free rotatability around 360° is ensured. The media line 10 extends from the rearward end of the handpiece 1 to its forward end region, whereby it may run in part as a channel in the instrument body or has a hose or pipe line. The media line 10 opens out in the forward end region of the handpiece 1 out of the handpiece, whereby the mouth opening 10a is directed towards the treatment site or the tip of the tool 6.

The main parts of the handpiece 1 are a base part 11 (FIG. 5) and a grip element 12, which surrounds the base part at least partially and preferably in ring form or sleeve form, whereby the grip element 12 is of at least two grip element parts 13, 14, of which one grip part, e.g. the grip part 14, is releasably connected with the other grip part, here with the grip part 13, and/or with the base part 11. In the case of the exemplary embodiment the first mentioned grip part 13 is non-releasably connected with the base part 11 e.g. formed in one-piece therewith or adhered thereto. For fastening of the releasable second grip part 14 there serves a fastening device 15 (FIG. 5), which is preferably formed by means of a quick-fastening connection, e.g. a latching device, and in the case of the exemplary embodiment co-operates with the grip part 13.

The base part 11 is surrounded in a ring form or sleeve form by the grip element 12 or by the grip parts 13, 14, wherein this covering over may extend in the longitudinal direction over the entire length of the base part 11 or only over a part of the length. The covering over extends preferably as far the rearward end of the base part 11. A forward end region of the base part 11 may project out of the covering of the grip element 12 or likewise be covered thereby. In the case of the exemplary embodiment, the base part 11 is formed by a hollow cylindrical base body which may be tapered in its forward region, wherein in the hollow space in the forward end region, the holder device 5, not shown in detail, may be disposed.

The grip parts 13, 14 may be lateral, e.g. segment-like part-ring form or half-ring form or shell or half-shell form parts, which lie on one another at a separation joint 16 extending substantially in the longitudinal direction of the base part 11 or handpiece 3, so that the separation joint 16 is closed to the outside. As a result, the parts need only lie on one another in the outer edge region 16a of the separation joint 16, in order to close the separation joint 16. Preferably the grip parts 13, 14 lie on one another with bearing surfaces 13a, 14a extending over the entire region of the separation joint 16.

In the case of half-shell form grip parts 13, 14 the separation joint 16 extends in the middle region of the base part 11, whereby the separation joint 16 may run in a longitudinal plane 17 longitudinally intersecting the longitudinal axis 1a of the handpiece 3 or slightly parallel thereto, as shown in FIG. 3. The longitudinal plane 17 is located in substance between the grip parts 13, 14. (FIG. 3)

It is advantageous if the separation joint 16 extends rearwardly in the longitudinal direction of the base part 11 or handpiece 2. The separation joint 16 may, however, also have a separation joint section 16b extending transversely to the longitudinal direction, which results in the one grip part 14 projecting axially over the other grip part 13. The transversely extending separation joint section 16b may extend straight or forwardly or outwardly curved in an arc shape, as shown in FIGS. 3, 5, and 6, whereby the separation joint section 16b emerges at the outer surface at a spacing a from the forward end of the longer grip part 14. The outer surfaces 18a, 18b of the grip parts 13, 14 transition steplessly into one another at the end of the outer surface of the separation joint outer edge 16a. Thereby, the respective surface regions transitioning into one another may selectively have an oblique disposition with reference to the longitudinal middle axis 1a.

Within the scope of the invention, the grip parts 13, 14 may form a grip element having an outer surface which is symmetrically shaped, with respect to the longitudinal middle axis 11a of the handpiece 1 or the base part 11. Such a handpiece 1 has the same surface constitution or grip conditions in any rotational disposition, insofar as its shape is concerned.

For different types of work or different qualities of the work to be carried out it is advantageous to have grip parts 13, 14 with different surface constitutions, which improves the fastness of grip and handling of the handpiece 1. One or both grip parts 13, 14 may have an outer surface shape deviating from a round or cylindrical cross-sectional form, in particular may have elevations 18a, 18b (FIG. 10) which may extend in each case in the circumferential direction over the entire circumferential extent U1, U2 or only over a part of the circumferential extent U1, U2, so that on one or both sides of the elevation 18a concerned circumferential surface sections are present which are sunken with regard to the elevation 18a. Seen transversely to the longitudinal direction of the handpiece 1, the elevation or elevations 18a, 18b may extend over the entire length L of the grip element 12 or handpiece 3 or only over a part of the length L, so that behind and/or before the elevation 18a, 18b sunken circumferential surface sections of the grip element 12 are present.

In the case of the exemplary embodiment according to FIGS. 1 to 4, in which at least the rearward longitudinal sections of the grip parts 13, 14 are arranged opposite one another, the grip part 13 non-releasably connected to the base part 11 has an elevation 18a which extends only over a part of the circumferential extent U1, so that on both sides of the elevation 18a, best to be seen in FIG. 4, sunken circumferential surface sections are present having the substantially radial cross-sectional dimension ra. The greater cross-sectional dimension, with reference to the middle axis 11a, is indicated by ra1 in FIG. 4.

In contrast, the releasable grip part 14 has an elevation 18b which extends over the entire circumferential extent U2 with a substantially uniform cross-sectional dimension rb. The elevation 18b can thus be described as a bulge or beading extending in the circumferential direction. As FIGS. 3 and 10 show, the ridges of the elevations 18a, 18b may have different or the same spacing c1, c2 from the rearward end of the grip element 12 or handpiece 1, whereby the elevation 18b of the releasable grip part 14 may be offset forwardly.

The elevations 18a, 18b may have spacings b1, b2 from the rearward end of the handpiece 1 or grip element 12 which are the same or different. In the region of this spacing, the cross-sectional form of the grip element may be cylindrical or the cross-sectional forms of the grip parts 13, 14 may be substantially half-shell shaped. The at least one elevation 18a, 18b can extend up to the forward end of the grip element 12, as FIG. 5 shows.

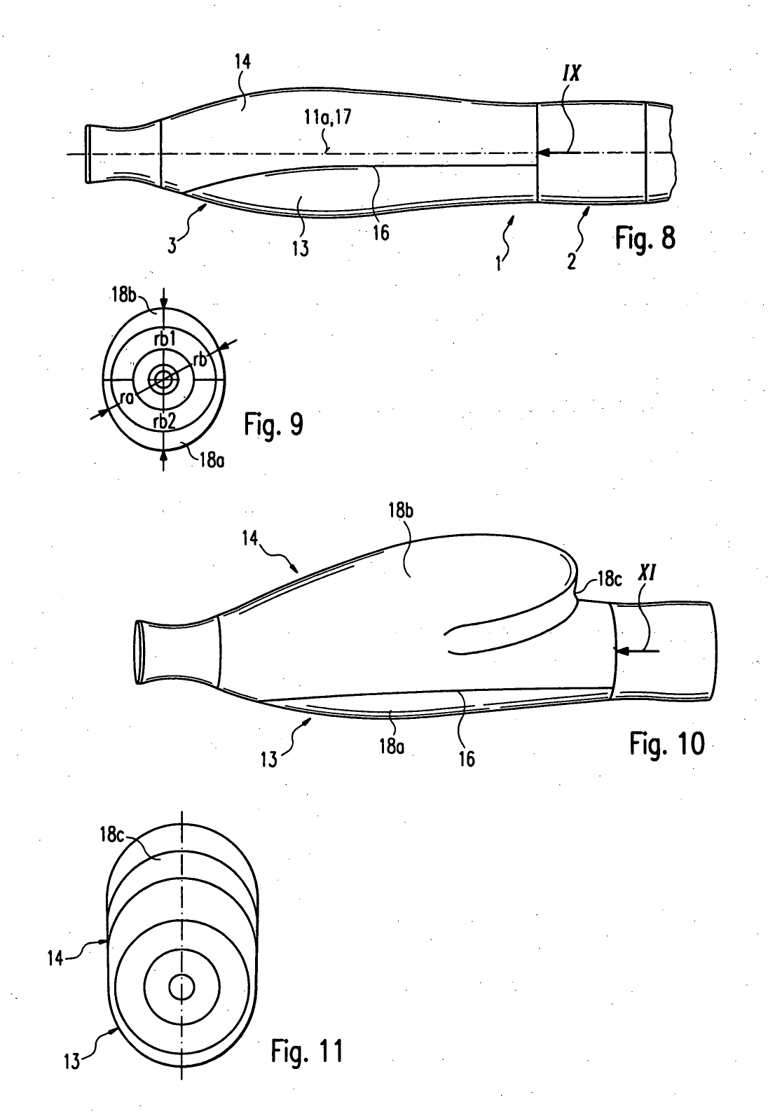

The exemplary embodiment of FIGS. 8 and 9 differs from the above-described exemplary embodiment in that also the elevation 18b arranged on the releasable grip part 14 may have on both sides sunken circumferential surface sections. The transverse dimensions ra1, rb1 of these elevations 18a, 18b may be the same or different, through which ellipse-shaped cross-sections result.

In the case of the exemplary embodiment of FIGS. 10 and 11, for example the releasable grip part 14 has an elevation 18b which on its rear side has a stepped surface 18c, which can serve for rearward support at a finger of the operating hand, e.g. the middle finger. This elevation 18b may extend e.g. as far as the rearward end region of the grip element 12. The stepped surface 18c may extend, rounded, as far as the rearward side regions of the elevations 18b.

In the above-described exemplary embodiments the base part 11 is e.g. formed by means of a hollow cylindrical tube, which may be tapered in the forward end region. The grip parts 13, 14 are thus arranged and supported on the outer surface of the hollow cylindrical base part 11. The free cross-section of the tube shaped base part 11 may form the coupling recess 7. The media line 10 may extend in the tube-like base part 11 or in the preferably non-releasable grip part 13 to open forwardly.

The fastening device 15, preferably formed as a latch device, has two latch noses 15a, arranged mutually transversely oppositely, which in each case engage behind a latch edge 15b on the grip part 13 (FIG. 7). The latch edge 15b may in each case be formed by means of a groove 13b which is located in the inner surface of the grip part 13 and which may e.g. extend as far as the rearward end of the grip part 13. The latch noses 15a may be arranged at the ends of a circular arc section shaped e.g. semicircular shaped, strip arc 18d and e.g. be bent outwardly, which strip arc is located in an arc shaped recess 13b of the grip part 14 and e.g. in its apex region 19 may be connected, e.g. by means of gluing, with the grip part 14. The strip arc 18d may be of spring elastic material, e.g. spring steel, through which the latch noses 15a are elastically yielding and by means of the spring force can spring in and latch behind the latch edges 15b. If the groove 13b extend as far as the forward end of the grip part 13 it is also possible to connect the grip part 14 in that it is pushed from the fore rearwardly on to the base part 11, whereby the latch noses 15a engage behind the latch edges 15b.

The parts of the handpiece 1, in particular the base part 11 and the grip parts 13, 14 are of corrosion resistant material, e.g. alloy steel or plastic.

In the exemplary embodiment of FIGS. 12 to 15, for which the same or similar parts are provided with the same reference signs, this differs from the above-described exemplary embodiments in that there are provided not two grip parts 13, 14, but two grip elements 12a, 12b, of which the one grip element 12a or the other grip element 12b can be selectively fastened to the base part 11. The base part 11 is likewise formed by means of a sleeve, preferably of hollow cylindrical cross-section, which projects forwardly from a rearward handpiece section 1b and which may have in the forward end region one or two longitudinal sections 11b, 11c arranged one behind the other and tapered stepwise. Here also the base part 11 forms a plug-in pin 21a on to which the grip elements 12a, 12b can be inserted or the plug connection parts can be plugged together. For this purpose the sleeve-form grip elements 12a, 12b have in each case a plug-in recess 21b which in the forward end region of the grip elements 12a, 12b is tapered to a smaller plug-in recess 12c, through which an inner shoulder surface 11d is formed therebetween, which in the condition of the grip element 12a, 12b concerned, pushed on to the base part 11, bears on the axially opposite step surface 11e of the base part 11.

For preventing a return movement of the grip elements 12a, 12b there is provided a return movement lock 22, which in the case of the present exemplary embodiment is formed by means of a screw element, with which the grip element 12a, 12b can be releasably firmly screwed on to the base part 11. For this purpose there may serve a front sleeve 23, which can be fastened on to the forward longitudinal section 11c, preferably by means of screws on to a longitudinal section 11c having an external thread.

For preventing rotation of the grip elements 12a, 12b a rotation lock 20 is effectively arranged between the base part 11 and the respective grip element 12a, 12b, which is formed by means of a locking pin 20a on the one connection part and a locking recess 20b, receiving the pin 20a, on the other connection part. In the case of the exemplary embodiment, the locking pin 20a is arranged on the plug-in pin 21a and the locking recess 20b is arranged in the grip element 12a, 12b. If the rotation lock 20 is arranged at a forwardly directed spacing from the plug-in pin foot, e.g. arranged in its forward region, the locking recess 20b may be formed by means of a longitudinal groove in the circumferential wall of the grip element 12a, 12b.

The grip elements 12a, 12b differ from one another through their surface or outer surface constitution. Through this, the fastness of grip of the grip element 12a, 12b and therewith the handling of the handpiece 1 is to be improved by form-fitting or frictional force. Further, the handpiece 1 can be adapted to different types of work or treatments through the selection or the exchange of at least two grip elements 12a, 12b, e.g. through the mounting of the grip element 12a of greater engagement moment, with which the person carrying out treatment can exercise a greater torque and/or pushing or pulling moment on the grip element 12a than is the case with the other grip element 12b.

This can be attained, for example, in that one of the two grip. elements 12a, 12b has a non-round cross-sectional shape and that the other grip element 12b has a round, e.g. cylindrical cross-sectional shape.

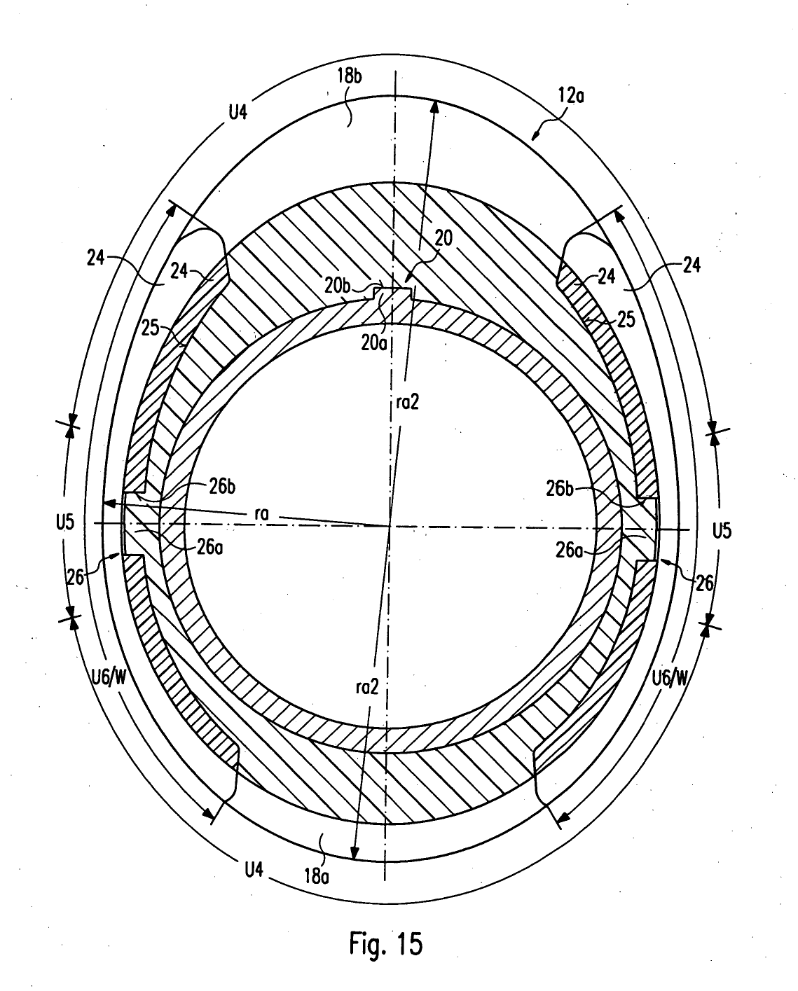

One or both grip elements 12a, 12b may, however, also have an elevation or a plurality of elevations arranged distributed around the circumference, e.g. two elevations 18a, 18b, which are offset in the circumferential direction, e.g. arranged opposite to one another, as in particular FIG. 15 shows.

An elevation 18a, 18b may extend over the entire circumference or only over a part of the circumference of the grip element concerned, or extend over the entire length L or only over a part of the length L of the grip element concerned. The grip element designated by 12a has two elevations 18a, 18b lying opposite to one another, which extend only over a part of the circumferential extent U3, so that to both sides of the elevations 18a, 18b, best seen in FIG. 15, sunken circumferential surface sections, having the in substance radial cross-sectional dimension ra, are present. The greater cross-sectional dimensions, with respect to the middle axis 11a, of the preferably differently high elevations 18a, 18b are designated by ra1, ra2.

As FIG. 13 shows, the ridges of the elevations 18a, 18b may have a non-equal or the same spacing c from the rearward end of the grip element 12. In the region of the spacing, the cross-sectional shape of the grip element may be cylindrical. The at least one elevation 18a, 18b can extend, reducing in height, as far as the forward end of the grip element 12, as FIG. 13 shows.

Also in the case of these exemplary embodiments, for different kinds of work or for different qualities of the work or treatment to be carried out, it is advantageous to have grip elements 12a, 12b the surface constitution of which is different, which improves the fastness of grip and handling of the handpiece 1. One or both grip elements 12a, 12b may have an outer surface shape deviating from a round or cylindrical cross-sectional shape, in particular have elevations 18a, 18b, which in each case extend in the circumferential direction over the entire circumferential extent or only over a part of the circumferential extent, so that to one or both sides of the elevation 18a concerned there are present circumferential surface sections U4 which are sunken with regard to the elevation 18a.

Seen transversely to the longitudinal direction to the handpiece 1, the elevation or elevations 18a, 18b may extend over the entire length L of the grip element 12a or 12b or only over a part of the length L, so that behind and/or before the elevations 18a, 18b there are present sunken circumferential surface sections U5 of the grip element 12a, 12b.

The parts of the handpiece 1, in particular the base part 11 and the grip elements 12a, 12b, are of a corrosion resistant material, e.g. of alloy steel or plastic.

For improving the handling and fastness of grip it is further advantageous to form at least one circumferential section U6 of the at least one grip element 12a, 12b with a material or material structure of different surface friction upon grasping with the operating hand.

In the case of the exemplary embodiment according to FIGS. 13 and 15, two such circumferential sections U6 of different grip friction are present, which are preferably arranged mutually oppositely, in particular on the two sides of one or of two elevations 18a, 18b, and may include approximately a circumferential angle W of about 45° to 90° or to 120° and more. The respective region U6 of different friction can be formed in that the grip element 12a or 12b concerned has in this region a material that upon grasping with the operating hand generates a greater friction than in the remaining circumferential region of the grip element 12a. Such a region is preferably formed in that an in particular flat material strip 24, having such an outer surface friction, is emplaced and fixed in a matching plug-in recess 25 in the circumferential surface of the grip element 12a, 12b.

The surfaces of the material strip 24 and of the adjoining circumferential surface sections of the grip element 12a, 12b end steplessly flush with one another, wherein in the region of the slope of an elevation 12a, 12b the circumferential surface sections bounding on one another run inclined upwardly or downwardly depending on the circumferential direction or longitudinal direction.

The recess 25 and the material strip 24 extend preferably in the longitudinal region of the at least one elevation 18a, 18b. The recess can also extend over approximately the length L and follow in its width d approximately the cross-sectional expansion and reduction of the elevations 18a, 18b.

The at least one material strip 24 may in each case be attached non-releasably or releasably in the plug-in recess 25. For a non-releasable connection the material strips 24 may e.g. be fixedly glued. For a releasable connection there is suitable e.g. a plug-in connection with a clamping effect.

Such a plug-in connection, illustrated in outline in FIGS. 12 and 15 and designated by 26 may in each case be formed by means of at least one plug-in pin 26a on the one connection part and an insertion hole 26b, preferably receiving the plug-in pin 26a, arranged on the other connection part. The material strip 24 may, by means of one or more such plug-in connections 26, arranged distributed at its inner side, be fixed in a clamped manner and thus readily installable or de-installable or exchangeable. In the case of the exemplary embodiment according to FIG. 15, the plug-in pin 26a is in each case formed on the circumferential wall of the grip element 12a, preferably in one piece, whereby the insertion hole 26b is located in the material strip 24. Thereby the insertion hole 26b may be a blind hole or a through hole, so that in the latter case, the plug-in pin 26a is visible.

In the case of the exemplary embodiment the material strip 24 is in each case of a material which, in the sense of a soft component, is softer than the material of the circumferential wall of the grip element 12a. The circumferential wall and the material strip 24 are preferably of plastic.

1.-33. (canceled)

34. Elongate medical handpiece having a base part and a grip element at, least partly surrounding the base part,
the grip element comprising at least two grip parts, one said grip part being releasably connected with at least one of the other grip part and the base part, the grip parts being configured that they lie on one another in a form-fitting manner.

35. Handpiece of claim 34, comprising a separation joint between the grip parts wherein the grip parts contact each other over an area on mutually facing joint surfaces of the separation joint.

36. Handpiece of claim 35, wherein the separation joint extends, at least partially, in a longitudinal direction of the handpiece.

37. Handpiece of 36, wherein the separation joint section extending in the longitudinal direction extends to the rear of the handpiece.

38. Handpiece according to claim 36, wherein the separation joint section extending in the longitudinal direction extends in a longitudinal plane or longitudinal middle plane.

39. Handpiece of claim 35, wherein the separation joint has a separation joint section extending transversely to the longitudinal direction of the handpiece.

40. Handpiece of claim 39, wherein the transversely extending separation joint section extends to the side of the handpiece.

41. Handpiece of claim 39, wherein one grip part projects forwardly beyond the other grip part and surrounds the base part in a ring shape.

42. Handpiece of claim 41, wherein the other grip part is non-releasably connected with the base part.

43. Handpiece of claim 34, wherein the grip parts are disposed with at least one longitudinal section thereof lying transversely opposite to another longitudinal section.

44. Handpiece according to claim 43, wherein at least the longitudinal sections form a grip element closed in the circumferential direction.

45. Handpiece according to claim 34, wherein the grip parts have different surface constitutions.

46. Handpiece of claim 34, wherein at least one grip part has an elevation on an outer side thereof.

47. Handpiece of claim 46, wherein both grip parts have an elevation and the elevation of the two grip parts have the same or different transverse dimensions.

48. Handpiece of claim 46, wherein the elevation extends over the entire circumferential extent or only over a part of the circumferential extent of the grip part.

49. Handpiece of claim 46, wherein the elevation extends over the entire length of the handpiece or only over a part of the length of the handpiece.

50. Handpiece of claim 46, wherein the elevation is located in forward end region or in the region of the forward half of the handpiece.

51. Handpiece of claim 46, wherein a longitudinal section of the grip part extending behind the elevation is shell-like in shape.

52. Handpiece of claim 34, wherein the base part is formed by a cylindrical tube.

53. Handpiece of claim 34, comprising two or more releasable grip parts, each grip part having a different surface constitution.

54. Handpiece of claim 34, wherein the elevation has a stepped surface in a rear portion thereof.

55. Elongate medical handpiece having a base part and a grip element at least partially surrounding the base part, the grip element being releasably attached to the base part, wherein at least two grip elements having different surface constitutions are provided, wherein one grip part can be selectively attached to the base part.

56. Handpiece of claim 55, comprising an attachment device, for attaching the respective grip elements, having at least one first attachment element on the base part and at least one second attachment element, cooperating with the first attachment element, on the grip element.

57. Handpiece of claim 56, wherein the base part comprises a plug-in pin which extends out from a rearward handpiece section, and the grip elements are sleeve-like in form with a plug-in recess and can be plugged together with the plug-in pin and secured against rotation and return movement.

58. Handpiece of claim 57, comprising a rotation lock between the plug-in pin and an associated grip element, the rotation lock having a rotation lock having a rotation lock pin on one part and a rotation lock recess on another part, and a return movement lock disposed between the plug-in pin and the grip element.

59. Handpiece of claim 58, wherein the return movement lock is formed by a screw.

60. Handpiece of claim 55, wherein at least one grip element comprises at least one elevation on its circumference.

61. Handpiece of claim 60, wherein the elevation extends over the entire length of the grip element or only over a part of the length or in that the elevation extends in a forward end region or in a region of the forward half of the grip element.

62. Handpiece of claim 60, wherein the elevation of the one grip element is higher than the elevation of the other grip element or the other grip element is formed without elevation.

63. Handpiece of claim 55, wherein at least one grip element has at least one outer surface region disposed on the circumference of the grip element, said surface region having a greater surface friction than a neighboring surface of the grip element.

64. Handpiece of claim 63, wherein the outer surface region comprises a material strip disposed in a recess.

65. Handpiece of claim 64, wherein the outer surface region is offset in a circumferential direction with reference to elevation.

66. Handpiece of claim 64, wherein the material strip is non-releasably attached.

67. Handpiece of claim 64, wherein the material strip is releasably attached.
